(19) United States
(12) Patent Application Publication
(10) Pub. No.: US 2003/0067958 A1
(43) Pub. Date: Apr. 10, 2003

(54) Infrared thermometer as measured on forehead artery area

(76) Inventor: Chen-Chang Jang, Lu-Chou (TW)

Correspondence Address: Chen-Chang Jang, P.O. Box 55-846, Taipei, 104, TW

(21) Appl. No.: 09/975,285

(22) Filed: Oct. 9, 2001

(51) Int. Cl. G01J 5/02

(52) U.S. Cl. 374/131; 374/158; 374/130

(57) ABSTRACT

An infrared thermometer includes: a thermal-mass sleeve concentrically mounted in a probe of the thermometer main body having a flat front rim of the probe, an infrared sensor thermally conductively secured to a bottom portion of the thermal-mass sleeve and connected to a printed circuit board fixed in the main body, and a disposable hygienic cap covering the probe, with the thermal-mass sleeve defining a conical hole tapered inwardly from an outer larger opening of the sleeve towards the bottom portion of the sleeve for passing the infrared radiation waves from a larger target surface of a patient's forehead artery sensing area, whereby the flat front rim of the probe will be planarly rested upon the patient's forehead surface for a comfortable reliable body-temperature measurement.

### BACKGROUND OF THE INVENTION

A conventional infrared medical thermometer includes an infrared radiation sensor having a hot junction exposed to the patient's ear canal and a cold junction maintained at a fixed or known temperature. The sensor generates a signal proportional to the temperature difference between the hot and cold junctions, whereby the patient's body temperature can be accurately measured.

However, the conventional infrared thermometer as measured in the patient's ear canal has the following drawbacks:

1. A probe cover or speculum should be mounted on a front portion of the thermometer, thereby increasing the production cost and measuring inconvenience.

2. The thermometer must be inserted into the ear canal to be easily contaminated by the dirts as accumulated in the ear canal.

3. Also, the dirts as accumulated in the ear canal may blockade or interfere the transmission of infrared waves, thereby influencing the measurement accuracy of the thermometer.

The present inventor has found the drawbacks of the conventional tympanic thermometer and invented the present thermometer measured on the patient's forehead.

### SUMMARY OF THE INVENTION

The object of the present invention is to provide an infrared thermometer including: a thermal-mass sleeve concentrically mounted in a probe of the thermometer main body having a flat front rim of the probe, an infrared sensor thermally conductively secured to a bottom portion of the thermal-mass sleeve and connected to a printed circuit board fixed in the main body, and a disposable hygienic cap covering the probe, with the thermal-mass sleeve defining a conical hole tapered inwardly from an outer larger opening of the sleeve towards the bottom portion of the sleeve for passing the infrared radiation waves from a larger target surface of a patient's forehead artery sensing area, whereby the flat front rim of the probe will be planarly rested upon the patient's forehead surface for a comfortable reliable body-temperature measurement.

### BRIEF DESCRIPTION OF THE DRAWINGS

FIG. 1 is a partial sectional drawing of the present invention.

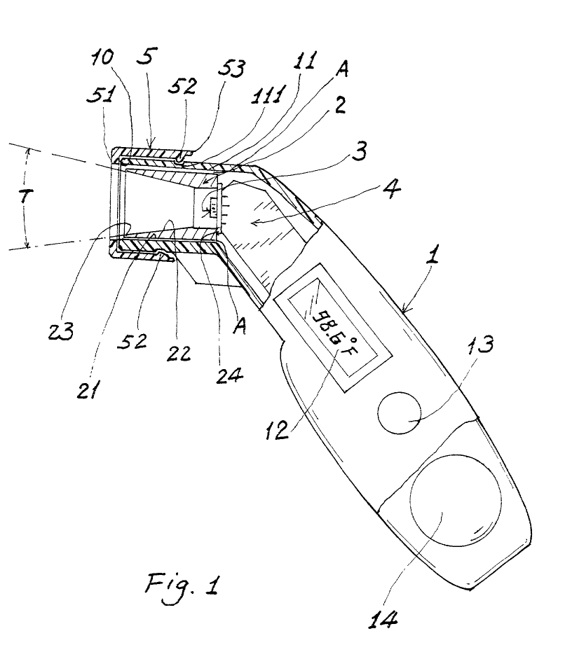

FIG. 2 is an illustration showing the measuring area of a patient's forehead in accordance with the present invention.

### DETAILED DESCRIPTION

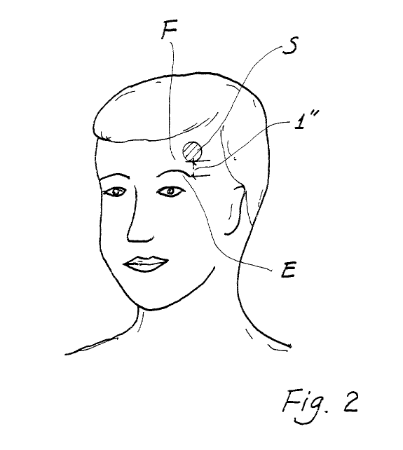

An shown in the drawing figures, the infrared thermometer of the present invention comprises: a main body 1 of the thermometer having a probe 11 formed on a front (or upper) portion of the main body 1 defining a central hole 10 in the probe 11 and having a flat front rim of the probe 11 adapted to be rested upon a patient's forehead F (artery sensing area S about one inch above the end of the eyebrow E) as shown in FIG. 2; a thermal-mass sleeve 2 concentrically formed in the central hole 10 of the probe 11, an infrared sensor 3 secured to a bottom portion 24 of the sleeve 2; a printed circuit board 4 connected with the sensor 3 and fixed in the main body 1; and a disposable hygienic cap 5 covering the front portion of the probe 11.

The main body 1 including the probe 11 is made of thermally insulating plastic materials, or other thermally insulating materials; and further includes: a display or readout window 12 for indicating the temperature data as measured by this thermometer, a switch 13 for switching on or off the circuit of the thermometer, and at least a battery 14 provided for power source of the thermometer.

The disposable hygienic cap 5 is also made of thermally insulating materials including thermally insulating plastic materials; and includes: a flat front rim having a central opening 51 formed in the front rim corresponding to the central hole 10 of the probe 11, a plurality of tenons 52 formed on a inside wall of the cap to be engaged with a groove 111 annularly recessed in the probe 11 for stably securing the cap 5 on the probe 11 and a plurality of lugs 53 each formed on a bottom rim of the cap 5 adjacent to each tenon 52 to serve as a “handle” for easily disengaging the tenons 52 from the groove 111 for detaching the cap 5 from the probe 11 for replacing a new cap 5 after each temperature measurement for every patient for hygienic purpose.

The thermal-mass sleeve 2 is made of high thermal conductivity materials including copper, aluminum, metal alloys, etc.

The thermal-mass sleeve 2 includes: a hollow cylinder 21 made of high thermal conductivity materials, a conical hole 22 formed through the hollow cylinder 21 and tapered inwardly or rearwardly from a front end 23 of the cylinder 21 towards a bottom portion 24 formed on a rear end of the cylinder 21 having the infrared sensor 3 secured to the bottom portion 24 of the cylinder 21 and thermally conducted with the cylinder 21; with the conical hole 22 defining a taper angle T tapered inwardly rearwardly and preferably ranging from 30 through 150 degrees.

The thermal-mass sleeve 2 of the present invention plays several important roles as follows:

1. The mass of the thickness of the hollow cylinder 21, i.e., the total mass of the cylindrical volume of the cylinder 21 minus the “mass” of the “conical volume” as occupied by the conical hole 22, will serve as a sufficient thermal mass or heat sink to quickly conduct heat generated from the sensor 3 and other adjacent elements of the present invention, thereby forming isothermal status among the elements or components of this invention for minimizing the unexpected thermal background radiation in order for increasing the measurement reliability of the present invention.

2. The conical hole 22 of the sleeve 2 is tapered inwardly rearwardly. In other words, the conical hole 22 is diverging forwardly outwardly to increase the target area for sensing the patient's forehead (artery sensing area S) since the thermal radiation emitted from the target surface is proportional to the temperature (t) of the surface raised to the fourth power (t⁴) and also proportional to the area of the sensing surface. So, the sensing area of the present invention is increased whereby the flat front rim of the probe of the present invention can be comfortably rested upon the patient's forehead surface.

The conical hole 22 also provides a path for passing the infrared radiation waves from the target (sensing) surface of the patient's forehead towards the sensor 3 secured on the bottom portion of the sleeve 2.

For measuring the patient's forehead temperature, the front rim of the cap 5 and the probe 11 is contacted with the patient's artery sensing area S (FIG. 2) to pass the infrared radiation waves from the sensing (target) surface to be sensed by the infrared sensor 3. The sensor 3 will detect the radiation waves for outputting electrical signal as converted from the radiation waves and send the signal to be processed by the printed circuit board 4 to be a readable digital data of temperature, which is then shown on the readout window 12 formed on the main body 1.

The present invention is especially suitable for measuring a patient's forehead temperature having arteries formed under the skin for sensitively detecting the patient's temperature, without using a conventional thermometer for tympanic temperature measurement having drawbacks as aforementioned (as shown in the paragraph of “Background of the Invention” of this specification). The flat front rim of the probe can be simply directly rested upon the patient's forehead surface for a comfortable body-temperature measurement. The construction of the present invention is simpler by eliminating the conventional complex element(s).

The cylinder 21 of the sleeve 2 should define an air gap A between the cylinder 21 and the inside wall of the probe 11 for thermally insulating the ambient heat into the sensor 3. The front rim of the sleeve 2 must also not be contacted with the front rim of the probe 11 and the cap 5.

The present invention is especially recommended for measuring the patient's thermally sensitive distribution area of the arteries on the forehead surface adjacent the eyebrows. So, this invention may also be designated as “Artery Thermometer”. The flat forehead surface is snugly contacted with the flat front rims of the cap 5 and probe 11 of the present invention for a comfortable touch feeling and ergonomic temperature measurement.

The present invention may be modified without departing from the spirit and scope of the present invention.

I claim:

1. An infrared thermometer comprising:
a main body having a thermally insulative probe formed on a front or upper portion of the main body having a flat front rim of the probe adapted to be rested upon a patient's forehead surface and having a central hole formed in said probe;
a thermal-mass sleeve concentrically formed in the central hole in said probe defining an air gap between said sleeve and an inside wall of said central hole of said probe for passing infrared radiation waves emitted from the patient's forehead surface inwardly rearwardly;
an infrared sensor secured to said sleeve for detecting the radiation waves passing through said sleeve and converting the radiation waves to be electrical signals;
a printed circuit board connected with said sensor and fixed in said main body for receiving and processing said electrical signals as detected from said sensor for obtaining readable digital temperature to be displayed on said main body; and
a disposable hygienic cap detachably covering said probe; the improvement which comprises:
said thermal-mass sleeve including: a hollow cylinder made of high thermal conductivity materials, a conical hole formed through the hollow cylinder and tapered inwardly rearwardly from a front end of the cylinder towards a bottom portion formed on a rear end of the cylinder having the infrared sensor secured to the bottom portion of the cylinder and thermally conducted with the cylinder; with the conical hole defining a taper angle tapered inwardly rearwardly; and
said hollow cylinder having a thickness formed as a thermal mass and heat sink for quickly conducting heat as generated in the thermometer to form an isothermal status in the thermometer.

2. A thermometer according to claim 1, wherein said taper angle ranges from 30 through 150 degrees.

3. A thermometer according to claim 1, wherein said disposable hygienic cap is made of thermally insulating materials and includes: a flat front rim having a central opening formed in the front rim corresponding to the central hole of the probe, a plurality of tenons formed on an inside wall of the cap to be engaged with a groove annularly recessed in the probe for stably securing the cap on the probe and a plurality of lugs each formed on a bottom rim of the cap adjacent to each said tenon to serve as a handle for easily disengaging the tenons from the groove for detaching the cap from the probe for replacing a new cap on the probe.

4. A thermometer according to claim 1, wherein said sleeve is made of thermally conductive materials including: copper, aluminum, aluminum alloy, and metals having high thermal conductivity.
